(19) United States
(12) Patent Application Publication
(10) Pub. No.: US 2011/0187195 A1
(43) Pub. Date: Aug. 4, 2011

(54) Intelligent Low-Consumption Adaptor

(76) Inventor: Jianhua XU, Shenzhen (CN)

(21) Appl. No.: 12/696,068

(22) Filed: Jan. 29, 2010

(51) Int. Cl. H02J 9/00

(52) U.S. Cl. 307/66

(57) ABSTRACT

An intelligent low-consumption adaptor includes a switch circuit, a control circuit and a standby circuit. The switch circuit can be connected to an AC power source. The control circuit includes a recharge switch connected to the switch circuit, an output unit connected to the recharge switch, and a MCU circuit connected to the recharge switch and the output unit. The standby circuit includes a standby turn-off circuit connected to the MCU circuit and an auxiliary power supply connected to the MCU circuit.

### BACKGROUND OF INVENTION

1. Field of Invention

The present invention relates to an electronic device and, more particularly, to an intelligent low-consumption adaptor for an electronic device such as a laptop computer, PDA, cell phone, walkman, MP3 player and MP4 player.

2. Related Prior Art

An adaptor is used to provide a proper current at a proper voltage to a miniature electronic device or electric appliance. An adaptor includes a shell, a transforming circuit and a rectifying circuit. Conventional adaptors can be classified into AC-output and DC-output types. A conventional adaptor can be used with a laptop computer, PDA, cell phone, walkman, MP3 player, MP4 player, telephone handset, game machine or translating machine. Conventional adaptors consume a lot of electricity in the range of 0.75 to 3 watts. Moreover, a conventional adaptor provides only a AC or DC port.

The present invention is therefore intended to obviate or at least alleviate the problems encountered in prior art.

### SUMMARY OF INVENTION

It is the primary objective of the present invention to provide an intelligent adaptor that consumes a small amount of electricity and shows the status of recharge.

To achieve the foregoing objective, the adaptor includes a switch circuit, a control circuit and a standby circuit. The switch circuit can be connected to an AC power source. The control circuit includes a recharge switch connected to the switch circuit, an output unit connected to the recharge switch, and a MCU circuit connected to the recharge switch and the output unit. The standby circuit includes a standby turn-off circuit connected to the MCU circuit and an auxiliary power supply connected to the MCU circuit.

Preferably, the output unit includes an output port set, a detecting circuit and a display module.

Preferably, the output port set includes a DC output terminal and a USB output terminal.

Preferably, the DC output terminal can be connected to a DC connector.

Preferably, the USB output terminal can be connected to a USB connector.

Preferably, the auxiliary power supply is a USB battery.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of an adaptor according to the preferred embodiment of the present invention; and

FIG. 2 is a circuit diagram of the adaptor shown in FIG. 1.

### DETAILED DESCRIPTION OF PREFERRED EMBODIMENT

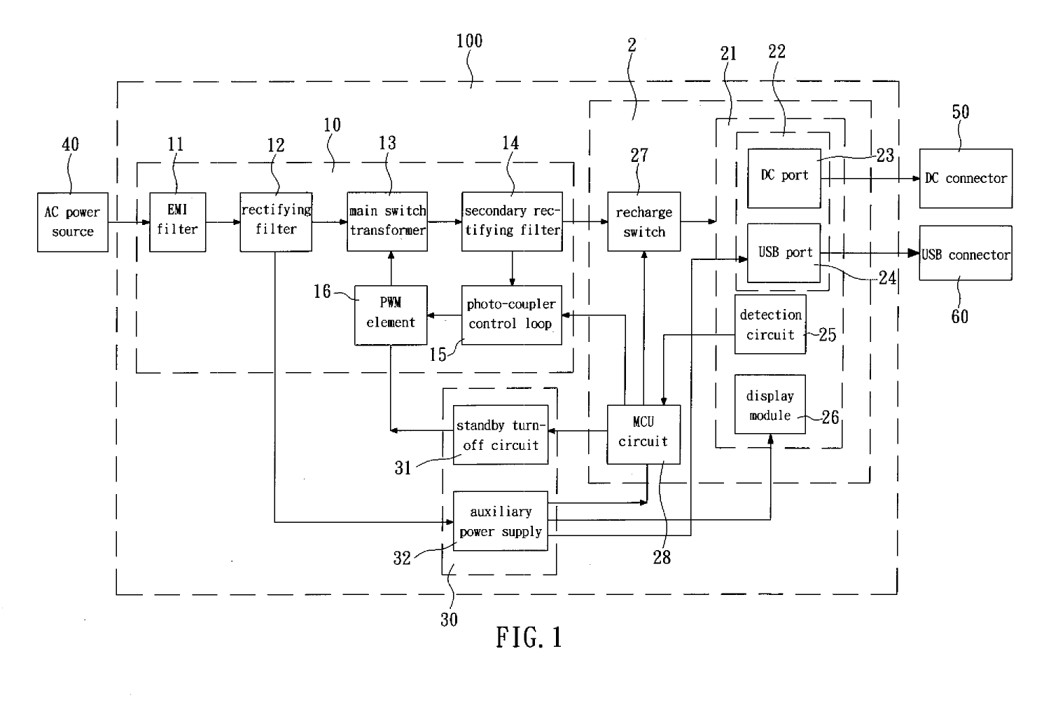

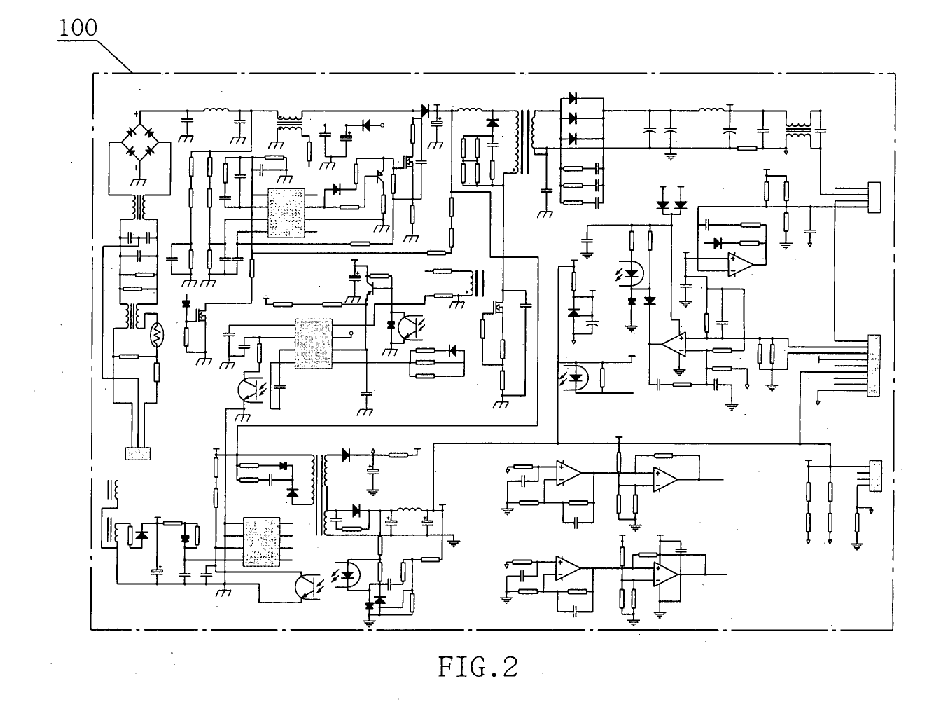

Referring to FIGS. 1 and 2, an adaptor (100) includes a switch circuit (10), a control circuit (20) and a standby circuit (30) according to the preferred embodiment of the present invention. In use, the switch circuit (10) is connected to an AC power source (40). The control circuit (20) is connected to the switch circuit (10). The standby circuit (30) is connected to the control circuit (20).

The switch circuit (10) includes an EMI filter (11), a rectifying filter (12), a main switch transformer (13), a secondary rectifying filter (14), a photo-coupler control loop (15) and a PWM element (16). In use, the EMI filter (11) is connected to the AC power source (40). The rectifying filter (12) is connected to the EMI filter (11), a main switch transformer (13) connected to the rectifying filter (12). The secondary rectifying filter (14) is connected to the main switch transformer (13). The photo-coupler control loop (15) is connected to the secondary rectifying filter (14). The PWM element (16) is connected to the photo-coupler control loop (15) and the main switch transformer (13).

The control circuit (20) includes an output unit (21), a recharge switch (27) and a MCU circuit (28). The recharge switch (27) is connected to the secondary rectifying filter (14). The MCU circuit (28) is connected to the recharge switch (27) and the photo-coupler control loop (15). The output unit (21) includes a port set (22), a detection circuit (25) and a display module (26). The port set (22) is connected to the recharge switch (27). The detection circuit (25) is connected to the MCU circuit (28). The output port set (22) includes a DC port (23) and a USB port (24). The DC port (23) can be connected to a DC connector 50. The USB port (24) can be connected to a USB connector 60.

The standby circuit (30) includes a standby turn-off circuit (31) and an auxiliary power supply (32). The standby turn-off circuit (31) is connected to the MCU circuit (28) and the PWM element (16). The auxiliary power supply (32) is connected to the display module (26) and the MCU circuit (28). The auxiliary power supply (32) can be a USB battery.

How the MCU circuit (28) enters a sleep status will be described. On connection of the switch circuit (10) to the AC power source (40), the adaptor (100) is initiated. The main output and the USB output are normal. The adaptor (100) can be loaded. However, if the adaptor (100) is not loaded or a load on the adaptor (100) is smaller than a lower limit within a period of time after the switch circuit (10) is connected to the AC power source (40), a current-sampling element 2R11 detects a signal and sends the signal to an operational amplifier 2U2D. The lower limit and the period of time are set via the MCU circuit (28). A voltage comparator 3U2A provides the MCU circuit (28) with a signal Vis. If the signal Vis continues to be low for another period of time set via the microprocessor circuit (28), the MCU circuit (28) takes it as a standby mode. A TR/Sta terminal provides a high voltage. Thus, Q1 and a photo coupler 1U4 are turned on while 1Q5 and the PWM circuit (16) are cut off. The main circuit is made idle, and the output from the main circuit is 0 volt. However, because the standby circuit is connected to the output through a resistor, the voltage is taken as the output. The voltage is predetermined. Hereinafter, only the standby circuit operates. If the USP is not loaded either, the consumption of electricity is very low.

In the standby mode, if the adaptor (100) is loaded, the standby voltage at the output terminal is lowered because the main circuit is idle. Because the resistance between the standby circuit and the main circuit is large, the load is only a few milli-amperes at most. A voltage drop occurs at a detection resistor 3R14. A voltage comparator U2B provides a low voltage. Thus, Q1 and the photo coupler 1U4 are cut off while 1Q5 and the PWM element (16) are turned on. The main circuit begins to operate again. The value of the voltage Vis is made high. The MCU circuit (28) is awake, and the adaptor (100) begins to operate normally.

How the adaptor (100) supplies electricity or recharge will be described. When no DC connector is connected to the adaptor (100), the adaptor (100) provides DC15V. When a DC connector is connected to the adaptor (100), resistance at a control terminal VR is changed. To retain the voltage at the control terminal VR, the voltage at the control terminal VR is compared with voltage at a datum pin, 2.5 volts. The operational amplifier 2U2A amplifies this signal and controls the intensity of the photo couple 1U4. The photo couple 1U4 sends the changed signal to a PWM chip 1U2. The PWM chip modulates the on and off and frequency of a MOS switch 1Q2. Thus, the magnetic energy is changed at the switch transformer (13). DC provided from the secondary rectifying filter (14) is changed. The voltage at the control terminal VR must be retained to automatically adjust the output voltage for a laptop computer or PDA.

On connection of a battery connector to the adaptor (100), the MCU circuit (28) begins to detect the voltage of a battery set. If the voltage V0 of the battery set is higher than 13.2 volts, the battery set is determined to include 4 batteries connected to one another in serial. The voltage at the control terminal VR continues to be high. A CR terminal provides a low voltage. A recharge switch Q2 is turned on. An upper limit of a recharge current is set to be 2.2 amperes. A back light of an LCD of the display module (26) is turned on.

If the voltage V0 of the battery set is 9.0 to 13.1 volts, the battery set is determined to include 3 batteries connected to one another in serial. The voltage at the control terminal VR continues to be high. The CR terminal provides a low voltage. The recharge switch Q2 is turned on. The upper limit of a recharge current is set to be 2.2 amperes.

If the voltage V0 of the battery set is lower than 9.0 volts, the recharge is extended for two minutes. If the voltage V0 is still lower than 9.0 volts, a TR terminal provides a low voltage. The recharge is stopped. The LCD flashes to indicate that the battery set is out of order.

The MCU circuit (28) is recharged with pulses. When the recharge pauses, the voltage V0 is detected. Thus, it is ensured that the battery set can be fully recharged but not overcharged. When the battery set is fully recharged, the LCD shows “FULL” in blue.

When the output terminal unit (22) is connected to a battery set instead of an AC load, the adaptor (100) recharges the battery set, and the LCD shows the energy level of the battery set. When an AC load is connected to the output terminal unit (22), the MCU circuit (28) is turned into a recharge mode through an RE pin.

The above-mentioned embodiment is given only for example. In another embodiment, based on the capacity and voltage of a battery set, the output voltage can be adjusted, a constant current of 0.1 ampere can be provided.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An intelligent low-consumption adaptor (100) comprising:
a switch circuit (10) for connection to an AC power source (40);
a control circuit (20) including a recharge switch (27) connected to the switch circuit (10), an output unit (21) connected to the recharge switch (27), and a MCU circuit (28) connected to the recharge switch (27) and the output unit (21); and
a standby circuit (30) including a standby turn-off circuit (31) connected to the MCU circuit (28) and an auxiliary power supply (32) connected to the MCU circuit (28).

2. The adaptor according to claim 1, wherein the output unit (21) includes an output port set (22), a detecting circuit (25) and a display module (26).

3. The adaptor according to claim 2, wherein the output port set includes a DC output terminal (23) and a USB output terminal (24).

4. The adaptor according to claim 3, wherein the DC output terminal (23) can be connected to a DC connector.

5. The adaptor according to claim 3, wherein the USB output terminal (24) can be connected to a USB connector (60).

6. The adaptor according to claim 1, wherein the auxiliary power supply (32) is a USB battery.
